(19) United States
(12) Patent Application Publication
(10) Pub. No.: US 2016/0086209 A1
(43) Pub. Date: Mar. 24, 2016

(54) SYSTEM AND METHODS FOR OFFER ACCEPTANCE

(71) Applicants: Theodore Frank, Chagrin Falls, OH (US); Carl Loskofsky, Wickliffe, OH (US); Douglas Martin Pierce, Perry, OH (US); Rushabh Sheth, Cleveland, OH (US); Douglas P.C. Hardman, Shaker Heights, OH (US)

(72) Inventors: Theodore Frank, Chagrin Falls, OH (US); Carl Loskofsky, Wickliffe, OH (US); Douglas Martin Pierce, Perry, OH (US); Rushabh Sheth, Cleveland, OH (US); Douglas P.C. Hardman, Shaker Heights, OH (US)

(21) Appl. No.: 13/842,417

(22) Filed: Mar. 15, 2013

Related U.S. Application Data
(60) Provisional application No. 61/694,227, filed on Aug. 28, 2012.

(51) Int. Cl. G06Q 30/02

(52) U.S. Cl. CPC G06Q 30/0211; G06Q 30/0225

(57) ABSTRACT

A system and method for capturing and processing data related to redemption of an offer from an issuer of offers. The system comprises a data capture device adapted to capture data relating to redemption of an offer; storage databases; a user interface; and a data processing device with the ability to communicate with storage databases and the user interface.

### CROSS REFERENCE TO RELATED APPLICATION

This application claims priority to U.S. Provisional Application No. 61/694,227, filed on Aug. 28, 2012, the entirety of which is incorporated by reference hereto.

### BACKGROUND OF THE INVENTION

In recent years, the availability of tools that help merchants attract new customers, increase customer frequency, and aid retention has grown exponentially. These tools allow merchants to target and acquire customers through various channels. As a result of these tools and numerous distribution channels, the merchant is left with difficult task of accepting various types or forms of offers, and determining the overall effectiveness of their efforts.

Tracking of offers and determining their effectiveness is a challenge for every merchant regardless of the tool they use. These challenges are compounded as they employ tools from different providers for different distribution channels. As a consequence the merchant is left to discern which tool, provider, and channel is the most effective.

Another important factor for merchants is offer validation. Validation of offers is key to prevent fraud and ensure proper tracking. Bar codes are the traditional method of tracking and validation of offers. However, merchants must enter these codes into a system, if a system even exists, beforehand for use. To add to the challenges, many merchants manually accept offers in lieu of using a computer system by relying on their employees to collect and validate the offers. These methods of offer acceptance make tracking and analysis of these offers difficult.

Today, merchants deal with an array of customer acquisition and marketing tools with little hope of adequately accepting offers and tracking the campaign effectiveness. Merchants need a way to accept and validate all the customer acquisition tools they use, preferably in an electronic format to enhance tracking and analysis.

### BRIEF SUMMARY OF THE INVENTION

The present invention addresses the needs of merchants, wherein the systems and methods are provided for accepting, validating, and managing all forms of offers a merchant might use as promotional tools.

In one aspect, a system for accepting, validating, and managing an offer, that is a coupon, incentive, reward, or gift, presented by a customer for redemption at a merchant is provided. The system generally comprises: a data capture device adapted to capture the offer data; a data processing device configured to receive the data representing the offer and send it to the databases; a user interface for the user to control the system and receive messages from the databases; and multiple databases to store and determine the validity of the offers. The databases would ideally be comprised of a centralized database, the merchant database, and as many issuer databases as needed. The data processing device would be in communication with the databases, ideally over a network.

In another aspect of the invention, a method for accepting, validating, and managing an offer presented by a customer for redemption at a merchant is provided. The method generally comprises: capturing the data related to the offer; storing the data; determining the format of the data; determining the issuer of the offer; extracting the relevant information from the data pertinent to the issuer; sending the information to the issuer database for validation; receiving the information back from the issuer database regarding the validity of the offer; and informing the user through the user interface. In an exemplary embodiment the success or failure of each step would be recorded in the merchant database with the offer.

In another aspect of the invention, a method for manually accepting, validating, and managing an offer presented by a customer for redemption at a merchant is provided. The method generally comprises: an offer being rejected; the user being notified of the rejection; the user electing to manually accept the offer; and the offer being accepted. In an exemplary embodiment the success or failure of each step would be recorded in the merchants database with the offer.

In another aspect of the invention, a method for using a manually accepted offer to accept, validate, and manage an offer presented by a customer for redemption at a merchant is provided. The method generally comprises: an offer being manually accepted; prompting the user if they wish to use the manually accepted offer for subsequent offer recognition; user electing to use the offer for subsequent offer recognition; copying the offer details from the merchant database to another database; and examining the data to determine the information needed to validate subsequent offers.

These and other aspects of the invention will become apparent to those skilled in the art with reference to the detailed description and drawings.

### BRIEF DESCRIPTION OF THE DRAWINGS

FIG. 1 illustrates an exemplary system in accordance with an embodiment of the invention.

FIG. 2 illustrates an exemplary process flow diagram for capturing and processing the offer.

FIG. 3 illustrates an exemplary process flow diagram for determining the issuer or the offer.

FIG. 4 illustrates an exemplary process flow diagram for validating the offer.

FIG. 5 illustrates an exemplary process flow diagram for manually accepting the offer.

FIG. 6 illustrates an exemplary process flow diagram for subsequent offer acceptance.

FIG. 7 illustrates the user interface for capturing the data related to an offer.

FIG. 8 illustrates the message sent to the user indicating an accepted offer.

FIG. 9 illustrates the message sent to the user indicating an issuer could not be found. It also gives the user the option to manually accept the offer.

FIG. 10 illustrates the message sent to the user indicating the offer could not be validated. It also gives the user the option to manually accept the offer.

FIG. 11 illustrates the user interface when the offer is manually accepted.

FIG. 12 illustrates the message when the offer has been declined.

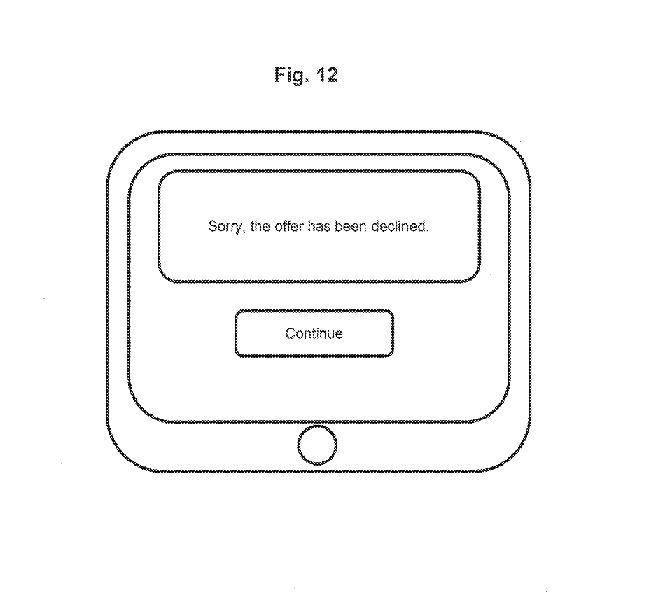

FIG. 13 illustrates the message to the user when an offer will be used for subsequent offer recognition.

FIG. 14 is a diagram of a general purpose computer system suitable for operating the present system and method.

FIG. 15 is a diagram of an exemplary environment for operating the present system and method.

### DETAILED DESCRIPTION OF THE INVENTION

The embodiments set forth below represent the necessary information to enable those skilled in the art to practice the invention. Upon reading the following description, in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention includes system and methods to allow merchants to accept, validate, and manage offers redeemed by customers. The merchants now have the ability to manage offers in different formats and offers from different issuers with one convenient system. Merchants have the ability to connect to databases or services run by the issuers of the offers, third parties, or can run the databases themselves. Even if an offer is not part of a database or service the merchant has the option to still accept the offer and use it for subsequent offers thereby easily building a database of offers to use in the future.

As used herein, an issuer is an entity who issues an offer and manages its validation. An issuer issues a promotional item and may define various promotional characteristics including, amongst other things: the subject matter the promotion applies to, the value, duration, and/or total number of a general type of related promotional items; as well as, the value and/or duration of an individual promotional item which is a member of a broader promotional campaign. In one aspect the issuing entity is the merchant, whereby the merchant produces, distributes, and accepts the offer from customers. In another aspect the entity could be another party that the merchant hires to produce and distribute the offer while the merchant can accept the offer from customers. Accordingly, the party that is responsible for the offer details is considered the issuer.

As used herein, a database is a collection of data or a way to access a collection of data. In one aspect the database can be a service that is run by the offer issuer, the merchant, or a third party. This service is used as an access point to the issuer's database where the offer details are stored. In another aspect the database is a more traditional relational database containing the information related to the offers. These relational databases can be compiled and maintained by the issuer, the merchant, or a third party.

As used herein, an offer is a promotional item which includes, but is not limited to: coupons, discounts, incentives, rewards, rebates, or any other instrument of value to a customer.

As used herein, a merchant is any entity that accepts the presented offer.

As used herein, a known offer is an offer type that is valid and should be accepted by the merchant. In one aspect the offer is generic in the sense that everyone receives the same offer. In this aspect the known offer would be the same that is presented for redemption. In another aspect the offer is unique to each person but the offer has characteristics that are similar to those related to it. In this aspect each offer could have the same characteristics but a different serial number. All these offers would be related to a known offer. In another aspect each unique offer distributed would be cataloged and used.

As appreciated by one of skill in the art, the present system and method in certain aspects is embodied as a method, data processing system and/or computer program product. Accordingly, the present invention may take the form of an entirely hardware embodiment with logic embedded in circuitry, an entirely software embodiment with logic operating on a general purpose computer to perform, or an embodiment combining software and hardware aspects. Furthermore the system and method in some aspects takes the form of a computer program product on a computer-readable storage medium having computer readable program code means embodied in the medium. Any suitable computer readable medium may be utilized including hard disks, CD-ROMs, optical storage devices, static or nonvolatile memory circuitry, or magnetic storage devices and the like.

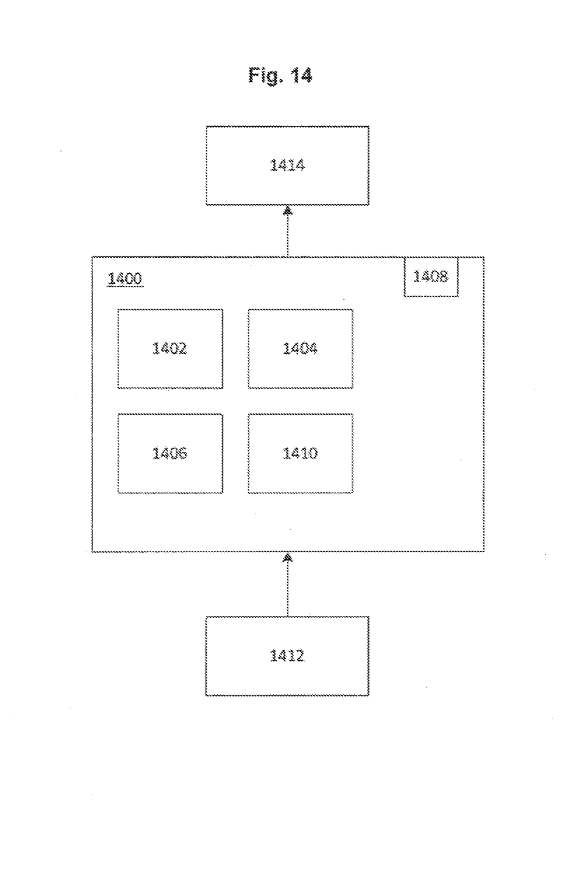

FIG. 14 depicts an exemplary computer system 1400, which can be used in implementation of the system and method. The computer system can be a laptop, desktop, server, handheld device (e.g., personal digital assistant (PDA), smartphone), programmable consumer electronics or programmable industrial electronics.

As illustrated the computer system includes a processor 1402, which can be any various available microprocessors. For example, the processor can be implemented as dual microprocessors, multi-core and other multiprocessor architectures. The computer system includes memory 1404, which can include volatile memory, nonvolatile memory or both. Nonvolatile memory can include read only memory (ROM) for storage of basic routines for transfer of information, such as during boot or start-up of the computer. Volatile memory can include random access memory (RAM). The computer system can include storage media 1406, including, but not limited to magnetic or optical disk drives, flash memory, and memory sticks.

The computer system incorporates one or more interfaces, including ports 1408 (e.g., serial, parallel, PCMCIA, USB, FireWire) or interface cards 1410 (e.g., sound, video, network, etc.) or the like. In embodiments, an interface supports wired or wireless communications. Input is received from any number of input devices 1412 (e.g., keyboard, mouse, joystick, microphone, trackball, stylus, touch screen, scanner, camera, satellite dish, another computer system and the like). The computer system outputs data through an output device 1414, such as a display (e.g. CRT, LCD, plasma . . . ), speakers, printer, another computer or any other suitable output device.

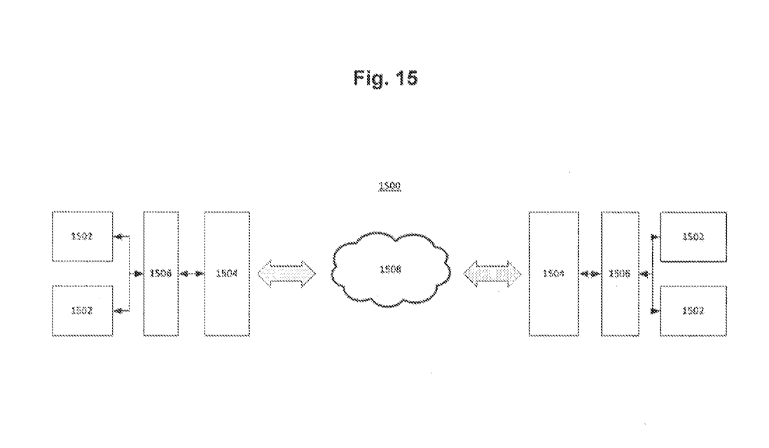

FIG. 15 depicts an exemplary computing environment 1500 for implementing the system and method. The computing environment 1500 includes one or more clients 1502, where a client may be hardware (e.g., personal computer, laptop, handheld device or other computing devices) or software (e.g., processes, or threads). The computing environment 1500 also includes one or more servers 1504, where a server is software (e.g., thread or process) or hardware (e.g., computing devices), that provides a specific kind of service to a client. The computing environment 1500 can support either a two-tier client server model as well as the multi-tier model (e.g., client, middle tier server, data server and other models). In embodiments, the protocol system is a client or hosted by a client device, and the central system is a server, or is hosted on a server.

The computing environment 1500 also includes a communication framework 1506 that enables communications between clients 1502 and servers 1504. In an embodiment, clients 1502 correspond to local area network devices and servers are incorporated in a cloud 1508 computing system. The cloud 1508 is comprised of a collection of network accessible hardware and/or software resources. The environment can include client data stores that maintain local data and server data stores that store information local to the servers, such as the module library.

The present invention is described below with reference to flowchart illustrations of methods, apparatus (systems) and computer program products. It will be understood that each block of the flowchart illustrations, and combinations of blocks in the flowchart illustrations, can be implemented by computer program instructions. These computer program instructions may be loaded onto a computer or other programmable data processing apparatus or otherwise encoded into a logic device to produce a machine, such that the instructions which execute on the computer or other programmable data processing apparatus create means for implementing the functions specified in the flowchart block or blocks. These computer program instructions may also be stored in a computer readable memory that can direct a computer or other programmable data processing apparatus to function in a particular manner, such that the instructions stored in the computer readable memory produce an article of manufacture including instruction means which implement the function specified in the flowchart block or blocks. The computer program instruction may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

As appreciated by those of ordinary skill in the art, specific functional blocks presented in relation to the present system and method are programmable as separate modules or functional blocks of code. These modules are capable of being stored in a one or multiple computer storage media in a distributed manner. In another aspect, these modules are executed to perform in whole or in part the present system and method on a single computer, in another aspect multiple computers are used to cooperatively execute the modules, and in yet another exemplary aspect the programs are executed in a virtual environment, where physical hardware operates an abstract layer upon which the present system and method is executed in whole or in part across one or more physical hardware platforms.

The data capture device will be able to capture the data relevant to the presented offers. It will be able to capture promotional characteristics in any number of data forms, including, but not limited to: sounds, images, video, and radio frequencies. The data capture device will also be able to capture specific, pending transaction data related to the specific promotional item and that data can include, but is not limited to: the subject matter of the pending transaction, the dollar amount, the time, the quantity of items, and any other data related to the purchase. The data capture device will contain the necessary technology to capture the data forms commonly presented, which may include a microphone and a camera. In another embodiment, the data capture device will also contain integrated software to capture data in the appropriate format; and/or preprocess the captured format to reveal the appropriate format. For example, the data form presented might be an image captured from a camera in the form of a QR code and the data capture device could include the software necessary to decode the QR code and the decoded data might be in the appropriate format or it might provide an internet link to the data in the appropriate format. In another example, the data format presented might be in the form of an audio signal captured from a microphone and the data capture device could include the software (e.g. Shazam) necessary to decode the audio signal into the appropriate format or it might provide an internet link to the data in the appropriate format. As appreciated by those of ordinary skill in the art, analysis algorithms are described along with standard statistical functions that are implementable through computer code or statistical analysis software.

The user interface will allow the user to operate the system as well as send/receive messages from the databases. The user interface may be a keypad with a display screen or a touchscreen.

The data processing device is a computing device that will process the captured data. The data processing device may connect to the databases as necessary and may do processing that cannot be done on the databases. It may also operate the data capture device if necessary. The data processing device will receive messages from the database and communicate them to the user through the user interface. As appreciated by those of ordinary skill in the art, the data processing device facilitates communication between the user interface, the data capture device and merchant database; and any one of these elements of the system may be combined, in part or in whole, with any other element of the system. For example, the functionality of the data capture device might be combined in the same component which houses the data processing device, or both of those components and their functionality may be housed in a component which also houses the user interface.

In one embodiment the data processing device processes the pending offer acceptance. The merchant database is used to store the offer details and information. The issuer database stores the necessary information to validate the offer, such as codes and dates. The data processing device may access both databases to determine the validity of the offer using the appropriate software known to those of ordinary skill in the art.

In one embodiment, the data processing device will perform the data processing functions such as determining the format, extracting the offer information from the data, and communicating with the issuer database in addition to operating the user interface.

In one embodiment a mobile device, such as a mobile phone or a tablet, may account for the majority of the system. They possess microphones and cameras for data capture with the ability to add additional peripherals for additional data capture. They possess the computing power and storage capabilities to act as the data processing device as well. The network connectivity present in most mobile devices allows them to communicate with the databases for offer validation. Mobile devices have the ability to function as a user interface as well.

In one embodiment a more traditional laptop computer may account for the majority of the system. The computer has the computing capabilities to function as the data processing device. In addition, it has the ability to capture all forms of data through the use of peripherals. They come with the ability to connect to the internet which will allow it to communicate with the appropriate databases. In this embodiment the user interface may be comprised of a mouse and a screen.

The merchant database is used to manage the offers and their validation status. The captured data is stored in the merchant database where the format of the data is determined. Information surrounding the capture such as time, date, and who accepted the offer, as well as the offer details are stored with the data.

In one embodiment the merchant database processes the offers in addition to storing and managing them. Using the appropriate software known to those of ordinary skill in the art, the merchant database determines the format of the data as well as determines the issuer of the offer. It then may contact the issuer database to determine the information needed by the issuer database which it extracts from the capture data. The merchant database sends the required information and receives validation messages back from the issuer database.

In one embodiment the merchant database is merely used for storage of the data and the information surrounding the acceptance of the offer. The data processing device will store the captured data in the merchant database. The data processing device will determine the format of the data and determine the issuer. It will contact the issuer database for the information required for validation. It will extract that information and send it to the issuer database. The issuer database will send the offer details and validation message to the data processing device for further operations.

In one embodiment the issuer database provides the merchant database with information regarding known offers. The issuer database may store information necessary to validate offers, such as acceptable codes and dates. The merchant database would access the issuer database and compare this information to information about the offer to be accepted. The merchant database would then determine the validity of the offer in addition to storing the details surrounding the pending offer acceptance.

In one embodiment the issuer database does all of the processing. The data processing device may send the captured data to the merchant database which stores the data then sends it to the issuer database. The issuer database will use the captured data to validate the offer. The offer information may be sent back to the merchant database for storage and then further processed to inform the user of validation.

In one embodiment, the issuer database is a validation service provided by the issuer of the offer. Once the merchant database determines the issuer it will contact the issuer service. The service will inform the merchant database of the information it needs to validate the offer. The merchant database will extract the relevant information from the offer and send it to the issuer service. The issuer service will validate the offer and send a message back to the merchant database indicating if the offer is valid and may be accepted. The issuer service can track the offers that have been accepted as well, in addition to the merchant.

In one embodiment a merchant may have multiple issuer databases that it uses to validate the offers it may accept. The merchant may use a service run by a third party, a service run by an issuer, as well as a database the merchant creates comprised of a list generated by another offer issuer.

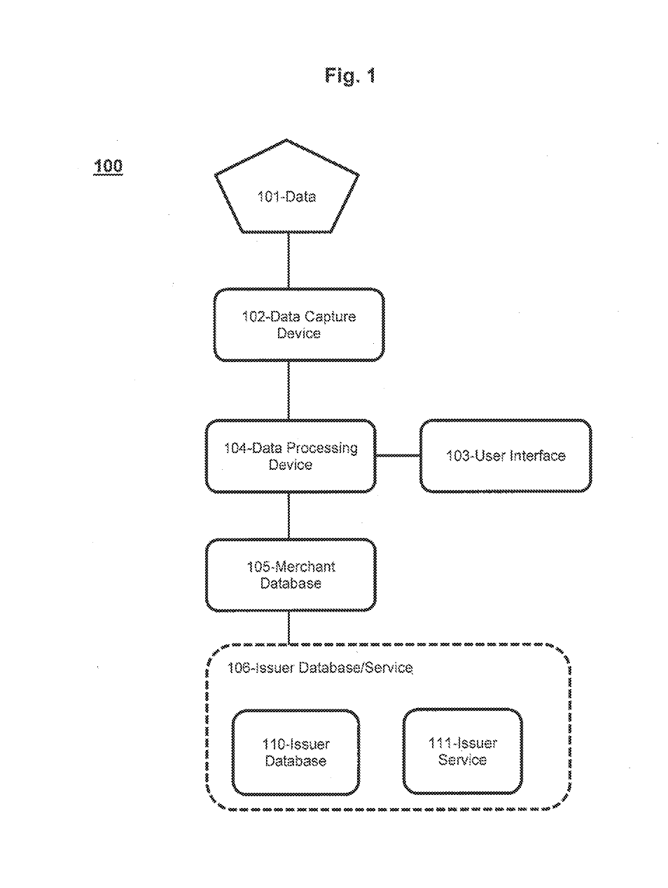

Referring to FIG. 1, a schematic depicts an embodiment of the system 100 for offer acceptance. In one embodiment the system includes a data capture device 102 connected to a data processing device 104. The user interface 103 is connected to the data processing device as well. Either a merchant database 105 or an issuer database system 106 can be connected to the data processing device 104, but in this exemplary embodiment only the merchant database 105 is in direct communication with the data processing device 104. The issuer database system 106 contains issuer databases and services. In this embodiment a service 111 provided by an issuer is used as well as a more traditional database 110 but for the present invention these two terms may be used interchangeably and implemented in the system as known by those of ordinary skill in the art.

The system is operated by the user with the user interface 103. The data 101 is captured by the data capture device 102, and processed by the data processing device 104. The data processing device 104 sends the data to the merchant database 105 where it is stored and operations are performed. The merchant database 105 interacts with the issuer database 106 to determine the validity of the offer. Messages are sent to the user interface 103 to inform the user on the validity of the offer.

As an example, the data 101 is an offer for a free taco. The user initiates the offer acceptance by way of the user interface 103 through the data processing device 104. The offer is captured by the data capture device 102, in the form of an image, and is sent to the data processing device 104. The data processing device 104 then determines the format of the data, in this example a JPEG file (.jpg). (This step of processing could be performed either just within the data processing device 104, just within the merchant database 105, or within both). The data processing device 104 determines the issuer of the offer by analyzing the data. The analyzing requires access to an issuer identification database (which may be located at the data processing device, the merchant database, or outside of the system but accessible to it) and it contains lists of a plurality of issuers and at least one known issuer format for each issuer, wherein the known issuer format is an identifiable format used by the issuers for formatting promotional items which they issue. The item format is then compared against known issuer formats; and an issuer of the promotional item is identified based on said comparison. In this example there is a barcode on the offer that is recorded by an image which contains data from which the data processing device 104 analyzes. The merchant database 105 is sent the results of that analysis and records the identity of the issuer based on the bar code.

The merchant database contacts the issuer database 106 to determine the information needed to validate the offer. In this example the issuer database 111 is a service. The issuer service 111 requests the barcode from the merchant database 105. The issuer service 111 receives the barcode from the merchant database 105 and validates the offer. The validation information is sent to the merchant database 105 where it is recorded. The merchant database sends the validation details to the user interface 103 through the data processing device 104.

In one embodiment a mobile device is used since it allows many of the components to be integrated in a portable device. Most mobile devices have the ability to function as the data capture device 102 by incorporating a camera, a microphone, and other data capture mechanisms through the use of peripherals. Mobile devices have the computing capabilities to function as the data processing device 104. Mobile devices contain user interfaces 103 which can be augmented using applications to function as the offer acceptance device. Mobile devices have the ability to connect to a network so that the data processing device 104 can connect to the merchant database 105.

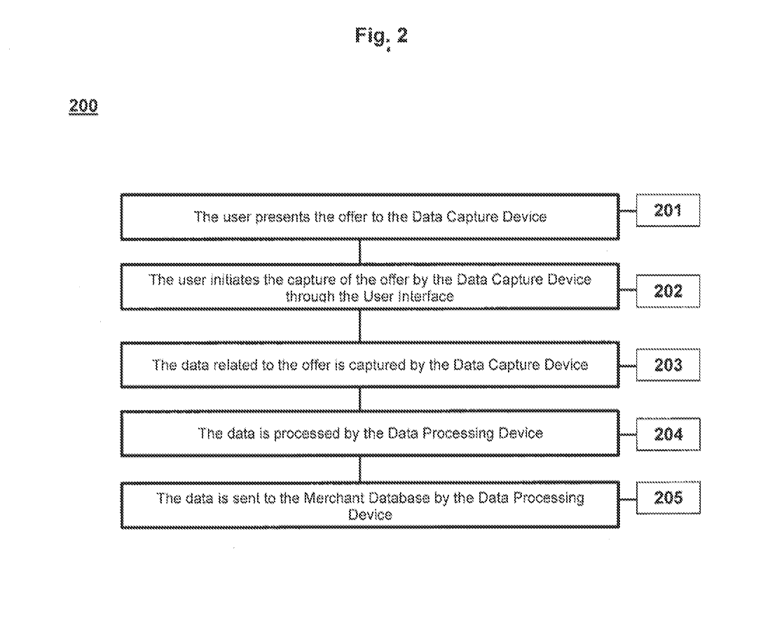

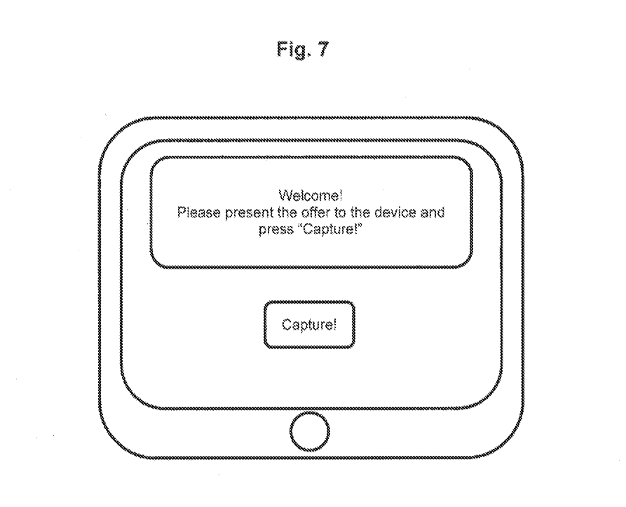

Now turning to FIG. 2 a method 200 for processing an offer for acceptance which will be described with regards to system 100. In accordance with exemplary method 200, the method generally involves at block 201 the user presenting the data 101 to the data capture device 102. To initiate the capture, block 202, the user interface 103, shown in FIG. 7, is used to control the data capture device 102 by way of the data processing device 104. At block 203 the data capture device 102 captures the data 101 representing the offer and sale information. The data processing device 104 processes the data 101 from the data capture device 102, block 204, which may just include sending the data to the merchant database 105, block 205.

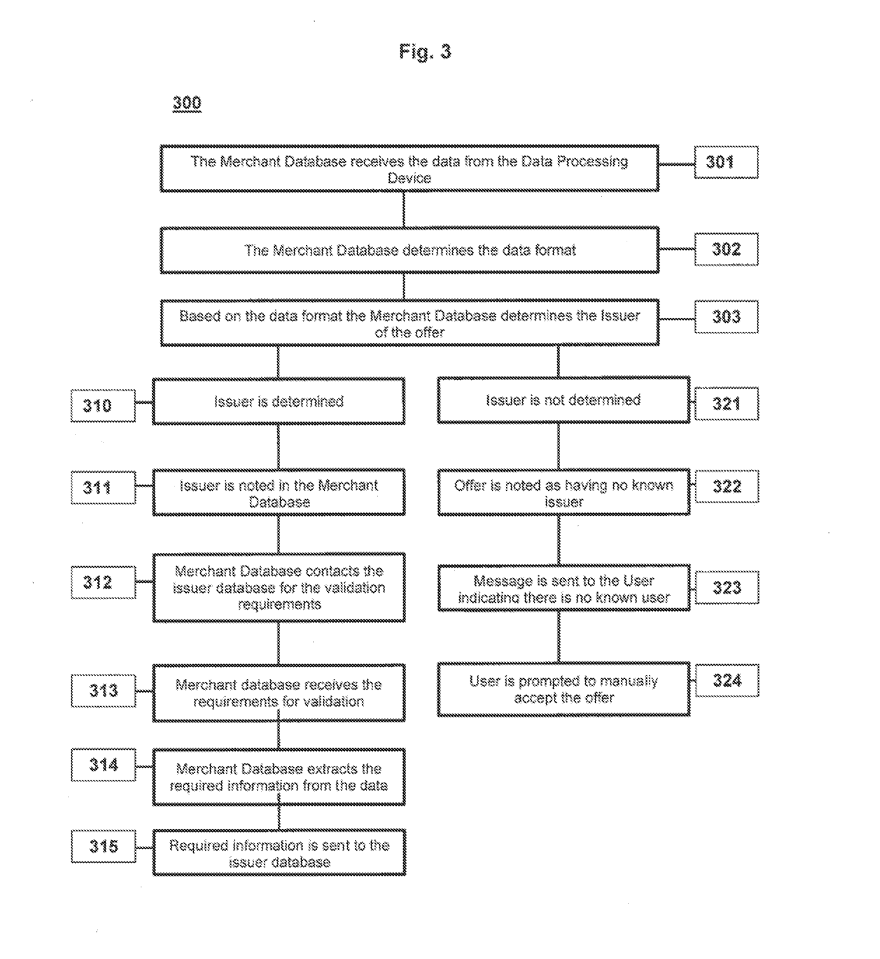

FIG. 3 shows an exemplary method 300 for determining the issuer of the offer by the merchant database, but note this step may also be performed by the data processing device. It will be described with regards to system 100. At block 301, the merchant database 105 stores the data 101 it receives from the data processing device 104. To determine the issuer of the offer the merchant database 105 first determines the format of the data, block 302. Using software and algorithms known to those of ordinary skill in the art, the merchant database 105 analyzes or scans the data to determine the issuer, block 303; this can be done any number of ways. With an image offer, for example the merchant database 105 may look for known image formats such as a barcode or a logo.

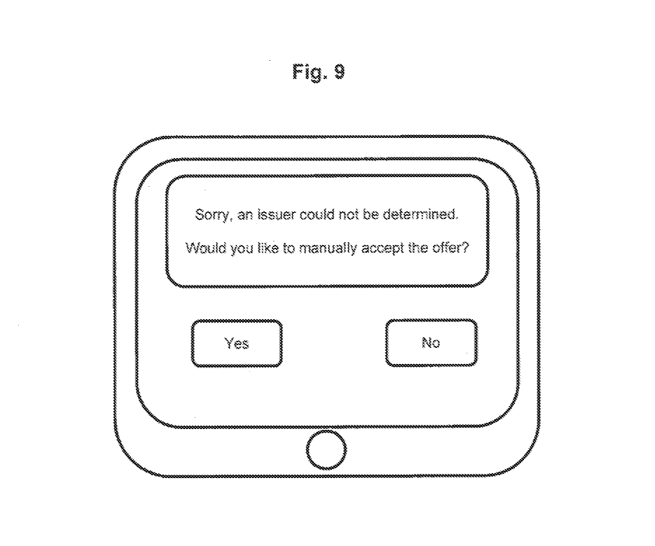

In one embodiment, block 321, the issuer could not be determined by the merchant database 105. The offer is noted in the merchant database 105 as having no known issuer, block 322. A message is sent to the user indicating that an issuer could not be determined, block 323. The message is displayed on the user interface 103, shown in FIG. 9, by the data processing device 104 after receiving the message from the merchant database 105.

In one embodiment, block 310, the issuer of the offer can be determined by the merchant database 105. The issuer is noted in the merchant database 105, block 311. The merchant database 105 interacts with the issuer database 106 to validate the offer, block 312. The issuer database 106 sends the validation requirements to the merchant database 105, block 313. The merchant database 105 extracts the required information from the data, block 314, and sends it to the issuer database 106, block 315.

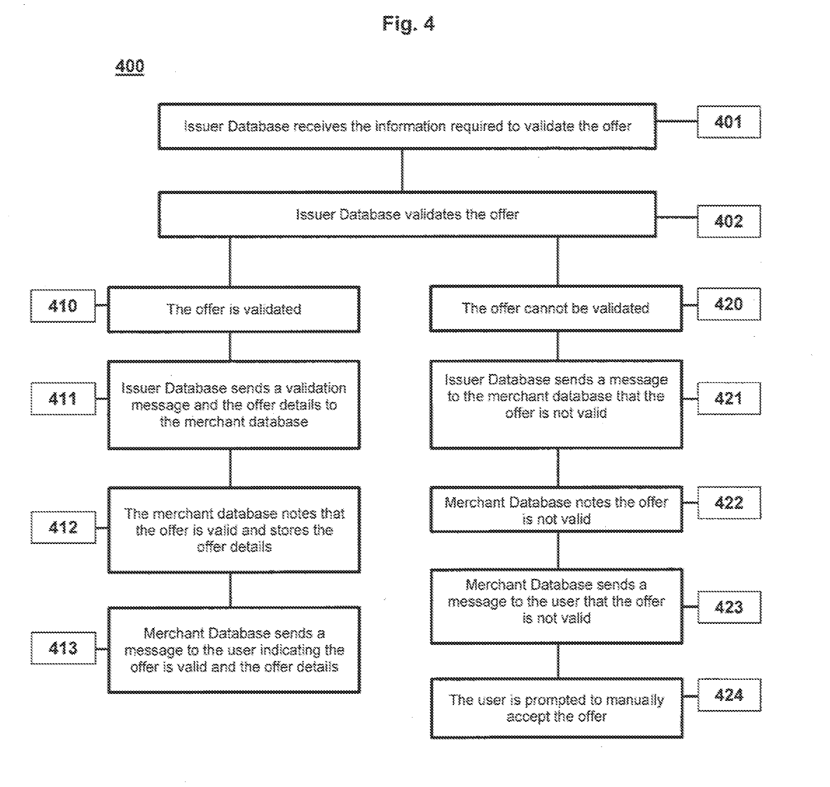

FIG. 4 shows an exemplary method 400 for validating the offer. It will be described with regards to system 100. The issuer database 106 receives the information required to validate the offer from the merchant database 105.

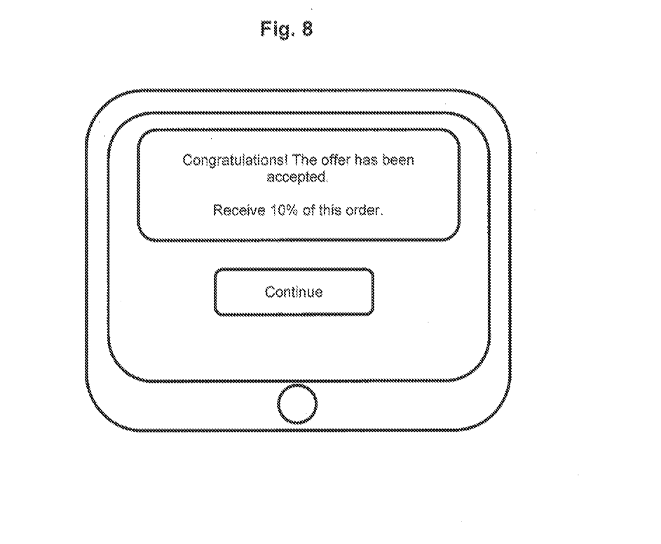

In one embodiment, block 410, the offer can be validated by the issuer database 106. The issuer database 106 sends a validation message reporting the validation status and the offer details to the merchant database 105, block 411. The merchant database 105 notes the validation status and stores the offer details, block 412. An acceptance message is sent to the user through the user interface 103, shown in FIG. 8, by way of the data processing device 104 from the merchant database 105, at block 413.

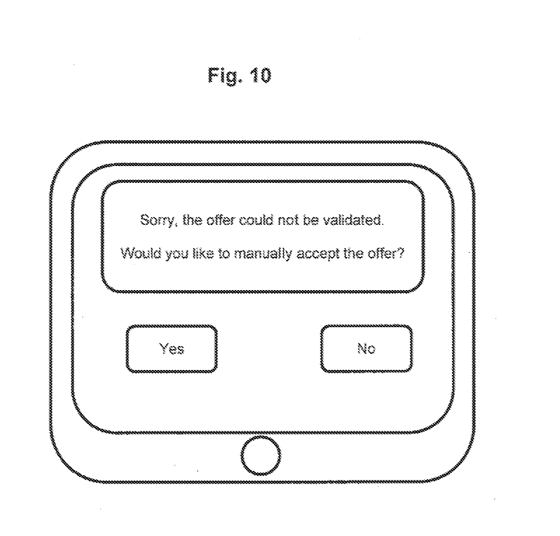

In one embodiment, block 420, the offer cannot be validated by the issuer database 106. The issuer database 106 informs the merchant database 105 that the offer cannot be validated, block 421. The merchant database 105 notes that the offer cannot be validated, block 422, and sends a message to the user, shown in FIG. 10, represented at block 423. The message is displayed on the user interface 103 and is transmitted by way of the data processing device 104.

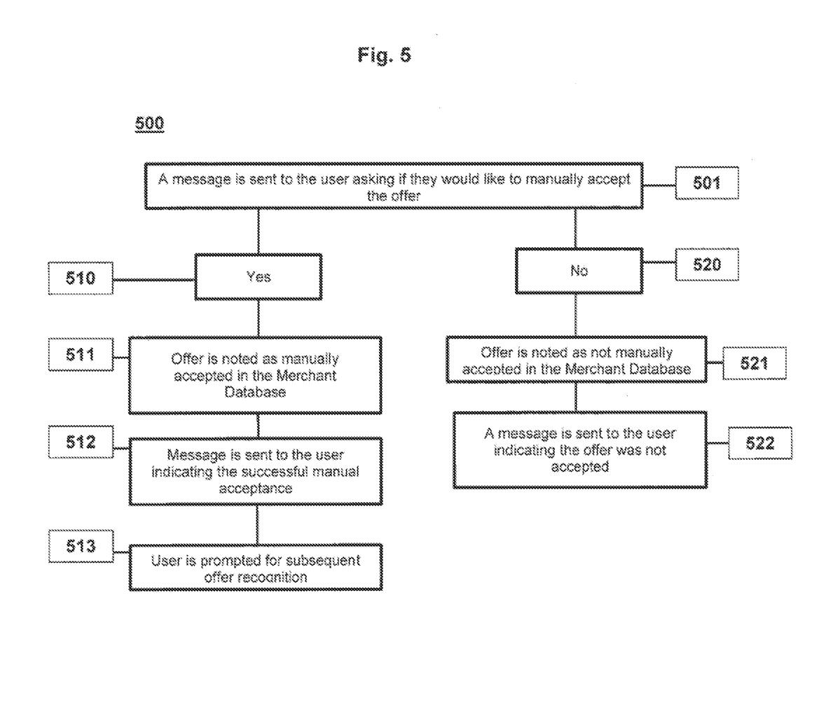

FIG. 5 shows an exemplary method 500 for the manual acceptance of unknown offers which will be described with regards to system 100. When an issuer cannot be determined or the offer cannot be validated the user may have the option to manually accept the offer. The option to manually accept the offer will be displayed on the user interface 103, shown in FIG. 9. This is shown at block 501 in system 500, block 324 in system 300 and block 424 in system 400.

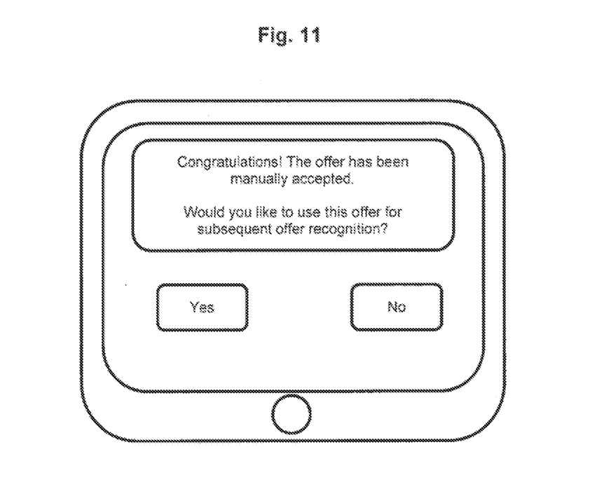

In one embodiment, block 510, the user wishes to manually accept the offer. Through the user interface 103, shown in FIG. 9 and FIG. 10, the user will instruct the merchant database 105 to manually accept the offer. The merchant database 105 will note that the offer has been manually accepted, block 511, and send a message back to the user indicating that it has been accepted, shown in FIG. 11, block 512. The message is sent by the merchant database 105 through the data processing device 104 to the user interface 103.

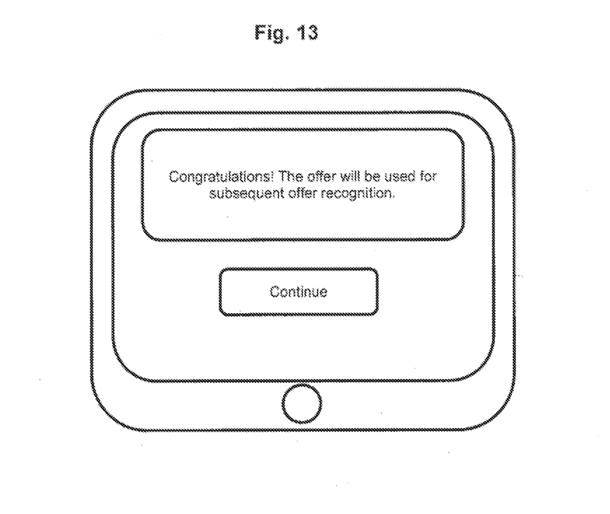

In one embodiment, the user interface 103 presents the user with the option to manually accept the offer but the user does not wish to accept the offer. Through the user interface 103, the user instructs the merchant database 105 to not accept the offer, block 520. The merchant database 105 notes that the offer was not accepted, block 521, and sends a message back to the user, shown in FIG. 13, that the offer was not accepted, block 522.

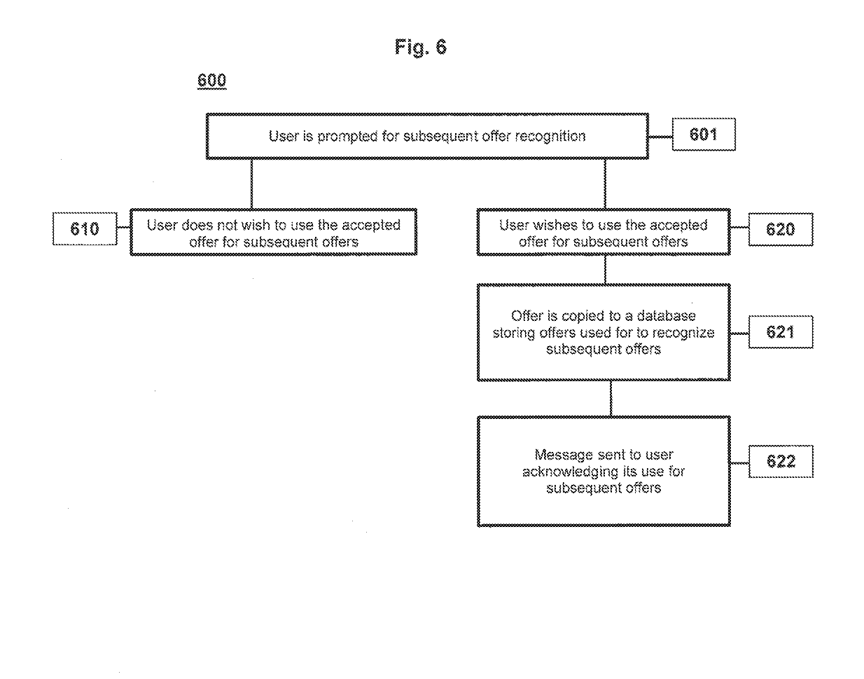

FIG. 6 shows an exemplary method 600 to use a manually accepted offer for subsequent offer recognition which will be described with regards to system 100.

In one embodiment, when a user manually accepts an offer they are prompted to use that offer when accepting subsequent offers, shown in FIG. 11. If the user declines to use the offer for subsequent offer recognition, block 610, the process is stopped.

In one embodiment, when a user manually accepts an offer they are prompted to use that offer when accepting subsequent offers, shown in FIG. 11. This step is represented by block 424 in system 400, block 522 in system 500 and 601 in the current system, 600. The user interface 103 is used to notify the merchant database 105 that the offer will be used for subsequent offer recognition.

In one embodiment, block 610, the user wishes the offer to be used for subsequent offer recognition. The merchant database 105 may create a subsequent offer database to operate like an issuer database 106. The merchant database 105 will send a message back to the user interface 103 indicating the offer will be used for the acceptance of subsequent offers, block 622. The offer data will be copied from the merchant database to the new issuer database 106, block 623.

In one embodiment, the subsequent offer database stores the data related to the offers to be used for subsequent offer recognition. The database is then manually updated either by the merchant or a third party. The update may include programming the database to recognize offers similar to those that were selected to be used for recognition of subsequent offers.

In one embodiment, the subsequent offer database stores the data related to the offers to be used for subsequent offer recognition. The subsequent offer database will be loaded with software known to those of ordinary skill in the art to allow automatic processing of the manually accepted offer. The software may be able to examine the data representing the offer and select unique elements that can be used for subsequent offer recognition.

In one embodiment, the subsequent offer database would contain software and algorithms known to those of ordinary skill in the art to extract the important characteristic from the manually accepted offer, these characteristics are needed to identify subsequent offers.

In one embodiment the manually accepted offer would be flagged to indicate additional processing steps are required to use the offer for subsequent offer validation. A person, the merchant or a third party, would manually populate the subsequent offer database based on the offers flagged.

### CONCLUSION

While various embodiments of the present system and method have been described above, it should be understood that the embodiments have been presented by the way of example only, and not limitation. It will be understood by those skilled in the art that various changes in form and details may be made therein without departing from the spirit and scope of the invention as defined. Thus, the breadth and scope of the present invention should not be limited by any of the above described exemplary embodiments.

What is claimed is:

1. A system for acceptance of promotional items comprising:
a data capture device which captures item information for at least one promotional item;
a data processing device which is capable of communicating with said data capture device and which processes said item information to determine an issuer identification value associated with said item information;
a merchant database which is capable of communicating with said data processing device and is capable of communicating with an issuer database, wherein said merchant database comprises a historic set of data relating to previously identified issuer identification values and a validation status for each previously identified issuer identification value, wherein said merchant database is capable of assigning an acceptance status to the promotional item, and wherein said merchant database is capable of communicating said acceptance status to a user interface.

2. The system of claim 1, wherein said data capture device is selected from the group consisting of: microphones, cameras, mobile phones and tablet computers.

3. The system of claim 2, wherein said item information comprises data related to promotional characteristics of said at least one promotional item and data related to a pending transaction.

4. The system of claim 3, wherein said issuer identification value identifies at least one unique issuer of the promotional item.

5. The system of claim 4, wherein said issuer database comprises a set of data listing a plurality of promotional items associated with at least one issuer and for each listed promotional item a set of data required for validation of said listed promotional item, wherein said issuer database is associated with said at least one unique issuer.

6. The system of claim 5, wherein said merchant database is capable of querying said issuer database for a set of data required for validation of the promotional item, wherein said merchant database is capable of receiving said set of data required for validation from said issuer database, wherein said merchant database is capable of extracting from said item information a subset of validation data from said item information which correlates to said set of data required for validation, wherein said merchant database is capable of sending to said issuer database a request for validation comprising said subset of validation data, wherein said merchant database is capable of receiving from said issuer database a validation status of said request for validation, and wherein said merchant database is adapted to assign said acceptance status to said promotional item based on said validation status.

7. The system of claim 3, wherein said issuer identification value is null and cannot identify at least one unique issuer of the promotional item, wherein said merchant database is capable of assigning a manual acceptance status of the promotional item, and wherein said merchant database is capable of updating said historic set of data to include said manual acceptance status.

8. The system of claim 7, wherein said user interface is capable of directing said merchant database in assigning said manual acceptance status.

9. The system of claim 3, wherein said validation status is null and no validation is confirmed by said issuer database, wherein said merchant database is capable of assigning a manual acceptance status of the promotional item, and wherein said merchant database is capable of updating said historic set of data to include said manual acceptance status.

10. The system of claim 9, wherein said user interface is capable of directing said merchant database in assigning said manual acceptance status.

11. A method for acceptance of a promotional item related to a pending transaction comprising:
capturing item information for at least one item, wherein said item information comprises data related to promotional characteristics of said at least one item and data related to the pending transaction;
processing said item information to determine an issuer identification value associated with said item information;
updating a merchant database with said issuer identification value;
assigning an acceptance status to said promotional item; and
communicating said acceptance status to a user interface.

12. The method of claim 11, wherein said issuer identification value has a null value, and wherein said acceptance status is a manual acceptance status.

13. The method of claim 11, wherein said verifying step further comprises:
querying said issuer database for a set of data required for validation of the promotional item, wherein said issuer database is associated with said unique issuer;
receiving said set of data required for validation;
extracting from said item information a subset of validation data from said item information which correlates to said set of data required for validation;
sending to said issuer database a request for validation comprising said subset of validation data; and
receiving from said issuer database a validation status of said request for validation.

14. The method of claim 13, wherein said validation status has a null value, and wherein said acceptance status is a manual acceptance status.

15. The method of claim 11, wherein said capturing step further comprises:
capturing said item information related to promotional characteristics with a data capture device; and
capturing said item information related to the pending transaction through a user interface.

16. The method of claim 11, wherein said processing step further comprises:
identifying an item format associated with said item information;
accessing an issuer identification database which contains lists of a plurality of issuers and at least one known issuer format for each issuer, wherein said known issuer format is an identifiable format used by said issuers for formatting promotional items which they issue;
comparing said item format against known issuer formats; and
identifying an issuer of the promotional item based on said comparison.

17. The method of claim 11, wherein a physical location of said issuer identification database is selected from the group consisting of: a data processing device, said merchant database, said issuer database, a centralized database.

18. The method of claim 11, further comprising:
updating said merchant database with a completed transaction data entry associated with said promotional item; and
analyzing a historic set of data relating to previously identified issuer identification values and completed transaction data entries to identify trends in said historic set of data.

19. A non-transitory computer readable storage medium having data stored therein representing software executable by a computer, the software including instructions to provide for the acceptance of promotional items, the storage medium comprising:
instructions for capturing item information for at least one item, wherein said item information comprises data related to promotional characteristics of said at least one item and data related to a pending transaction;
instructions for processing said item information to determine an issuer identification associated with said item information; wherein said issuer identification identifies a unique issuer of the promotional item;
instructions for updating a merchant database with said issuer identification;
instructions for querying an issuer database for a set of data required for validation of the promotional item, wherein said issuer database is associated with said unique issuer;
instructions for receiving said set of data required for validation;
instructions for extracting from said item information a subset of validation data from said item information which correlates to said set of data required for validation;
instructions for sending to said issuer database a request for validation comprising said subset of validation data;
instructions for receiving from said issuer database a validation status of said request for validation;
instructions for assigning an acceptance status to said promotional item; and
instructions for communicating said acceptance status to a user interface.

20. The non-transitory computer readable storage medium of claim 19, wherein said instructions for processing further comprise:
instructions for identifying an item format associated with said item information;
instructions for accessing an issuer identification database which contains lists of a plurality of issuers and at least one known issuer format for each issuer, wherein said known issuer format is an identifiable format used by said issuers for formatting promotional items which they issue;
instructions for comparing said item format against known issuer formats; and
instructions for identifying an issuer of the promotional item based on said comparison.
